(19) United States
(12) Patent Application Publication
(10) Pub. No.: US 2026/0099084 A1
(43) Pub. Date: Apr. 9, 2026

(54) Camera Tripod

(71) Applicants: Drew Miles, II, El Cajon, CA (US); Paul Tarpy, Santee, CA (US); Broc Kelly, El Cajon, CA (US)

(72) Inventors: Drew Miles, II, El Cajon, CA (US); Paul Tarpy, Santee, CA (US); Broc Kelly, El Cajon, CA (US)

(21) Appl. No.: 19/352,343

(22) Filed: Oct. 7, 2025

Related U.S. Application Data
(60) Provisional application No. 63/704,420, filed on Oct. 7, 2024.

(51) Int. Cl. G03B 17/56; F16M 11/32

(52) U.S. Cl. CPC G03B 17/561; F16M 11/32; F16M 2200/027

(57) ABSTRACT

A tripod for support of a camera or other component from a steady platform is provided. The tripod has a plurality of hollow legs having an axial passage running therein engaged at first ends with the platform and extending to distal ends. A solid metal rod is coupled within the axial passage of each of the legs at or adjacent the distal ends to thereby provide weighted distal ends which resist a tipping of the tripod. The metal rods may extend from the distal ends to be employed as spears for insertion into the underlying support surface for the tripod.

This application claims priority to U.S. Provisional Patent Application Ser. No. 63/704,420 filed on Oct. 7, 2024.

### BACKGROUND OF THE INVENTION

### 1. Field of the Invention

The present invention relates to tripod devices which are widely employed in photography as well as in other situations, such as for telescopes and surveying. More particularly, it relates to a tripod having weighted leg sections which are employable to situate a tripod and hold it steady in unsteady conditions, such as high winds.

### 2. Prior Art

In photography and other endeavors requiring support of a measuring or viewing component, a tripod is a portable device widely employed for support and stabilization of cameras and other instruments. Tripods are also widely used to hold instruments and cameras at a fixed elevation while they are in use.

Conventionally, almost all photographic tripods have three legs which extend to a mounting head. This mounting head is adapted for coupling to a camera or other component requiring such an elevated and stable positioning. The mounting head, conventionally, will include a thumbscrew or the like which is configured to mate and engage with a female-threaded receptacle on the camera. The mount, conventionally, will include a mechanism enabling the rotation and tilting of the camera, when it is mounted and maintained at a static elevation on the tripod.

Conventionally, tripod legs are frequently configured to telescope in order to save space when the tripod is being stored or transported while not in use as well as to adjust the height of the mounting head to a desired elevation. The material forming such legs varies, but conventionally, where weight is a primary issue for users who must carry a tripod to and from destinations, tripods are usually made from light weight materials. By light weight materials herein is meant materials such as aluminum, carbon fiber, fiberglass, polymeric material, wood or plastic, all formed in hollow members having an axial passage within.

In order to maximize strength and stability, conventional photographic tripods may be braced around a center post. The tripod also includes a plurality of collapsible telescoping legs along with a telescoping section at the top which may be elevated or lowered. As noted, at the top of the tripod is positioned the mounting head which includes the camera mount along with mechanical components which allow a mounted camera to pan, rotate and tilt. Ideally this camera motion may be achieved by the user without jostling the camera. Because of the focus on lightweight components and construction, tripods can become unsteady in windy situations since the heavy camera or other mounted component is mounted at the top of the lightweight legs supporting it and this provides leverage to tip the tripod in some cases.

The forgoing examples of related art and limitations related therewith as to tripods are intended to be illustrative and not exclusive, and they do not imply any limitations on the weight enhanced tripod device herein. Various limitations of the related art will become apparent to those skilled in the art upon a reading and understanding of the specification below and the accompanying drawings.

### SUMMARY OF THE INVENTION

The device herein provides for the stabilization of tripod-mounted cameras and instruments especially in areas with high wind. The tripod device herein includes a plurality of legs or members which are extendable from collapsed positions to elongated positions to provide a support and stable platform for engaging the supported instrument. In addition to a plurality of telescopically engaged legs, the device herein includes also includes a plurality of weights or rods. These rods are configured to be positionable within axial passages of the legs at lower ends thereof. The mass of the rods, so positioned, helps to maintain the platform supported by the legs in a steady position where the tripod device might be impacted by wind.

In one configuration of the tripod device, the rods or weights are formed in a unitary structure configured for sliding engagement into the axial passage of one or preferably the plurality of legs. In another mode of the tripod device herein, the rods for providing the extra weight to the legs, may be formed in separable sections. This separable configuration allows the user to choose the number of sections to position within the legs to provide the mass sufficient to hold the platform steady in the intended environment the tripod device will be employed.

In another mode of the tripod device herein, the weight rods may be formed to function as ground spikes. In this configuration the rods may be configured to project from the distal ends of the legs at the lower end thereof where ground spikes are desirable. These projecting portions may then be forced into engagement with soil or the underlying support surface for the tripod. When not projecting from the legs, the weight rods may be reversed to project into the axial passage of the leg to which it is engaged.

With respect to the above description, before explaining at least one preferred embodiment of the herein disclosed camera tripod with internal weights in detail, it is to be understood that the invention is not limited in its application to the details of construction and to the arrangement of the components in the following description or illustrated in the drawings.

The invention herein which discloses in the most preferred modes thereof after testing and design, is capable of other embodiments and of being practiced and carried out in equivalent ways which may be discerned by those skilled in the art upon review of this disclosure. Also, it is to be understood that the phraseology and terminology employed herein are for the purpose of description and should not be regarded as limiting.

As such, those skilled in the art will appreciate that the conception upon which this disclosure is based, while disclosed in various preferred modes thereof, may readily be utilized by those skilled in the art subsequent to review of this specification, as a basis for the design of other configurations of the tripod herein and for carrying out the several purposes of the present disclosed tripod device. It is important, therefore, that the claims be regarded as including the such equivalent devices and equivalent construction and methodology therefor insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Finally, unless provided with a different respective definition, the term substantially herein means plus or minus five percent.

It is an object of this invention to provide an easily transported tripod which will better resist tipping and movement in unstable situations, such as high winds.

It is an additional object of this invention to provide such a tripod which includes a plurality of elongated weight members to provide better stability to the deployed tripod.

It is yet an additional object of this invention to provide a weighted tripod where the insertable rods providing weight may be adjusted in size for mass and changed in position to provide enhanced anchoring.

These and other objects of the weighted tripod invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the weighted tripod device herein. It is intended that the embodiments and figures disclosed herein are to be considered illustrative rather than limiting. In the drawings:

FIG. 1 depicts an expanded depiction of the tripod device herein depicted in an as-used positioning showing the preferably solid metal rods being removably positionable to locations within an axial passage of one or a plurality of the legs of the tripod at the distal ends of a portion of each of the telescopic legs.

FIG. 1A depicts the device herein in a collapsed position wherein the second member sections have been slid over or into the first member sections.

FIG. 2 shows a depiction of the tripod device herein wherein the solid heavy rods are in an extended position from the lower ends of each of the telescopic legs of the tripod.

FIG. 3 shows an enlarged perspective view of one of the plurality of solid rods employed in the tripod herein.

FIG. 4 depicts the tripod device where separable rods are employed to allow for adjustment of the total weight of each leg.

FIG. 5 shows the device having reversible rods positionable to project from the distal end of the legs and provide both weight and operate as a ground spike.

FIG. 6 shows a sectional view through FIG. 5 and showing the engagement of the rod with the cap or support at the engaged with the distal end of the legs.

FIG. 7 shows the device of FIGS. 5-6 with the rod reversed for storage but concurrently providing mass at the distal end of the tripod leg.

FIG. 8 shows the device as in FIG. 5, in a sectional view thereof where a pointed portion of a rod is positioned within the leg or may be positioned within a hollow end of another rod portion.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the disclosed tripod device as it is oriented and appears in the drawings and are used for convenience only. The language is not intended to be limiting or to imply that the tripod device herein or components thereto have to be used or positioned in any particular orientation.

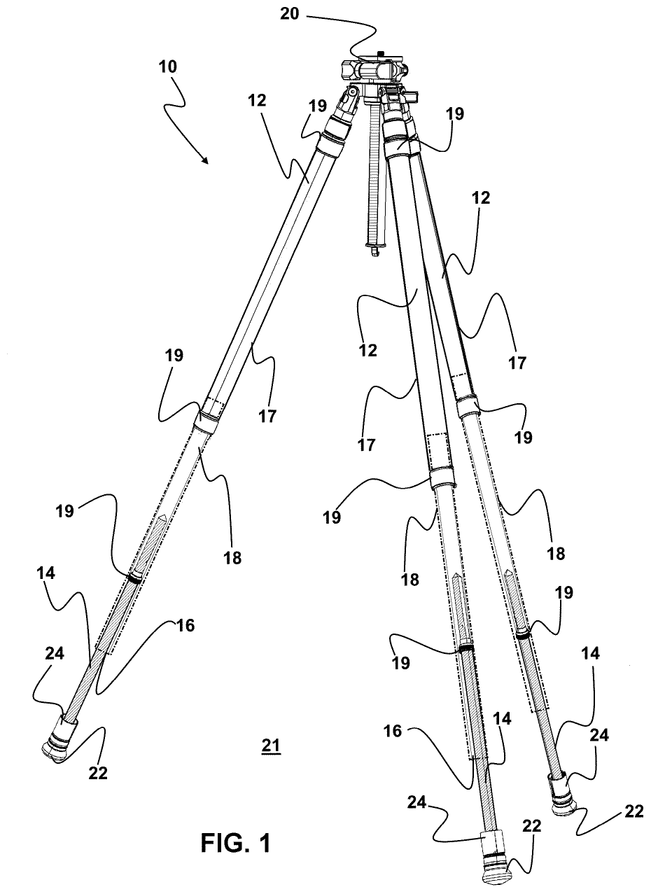

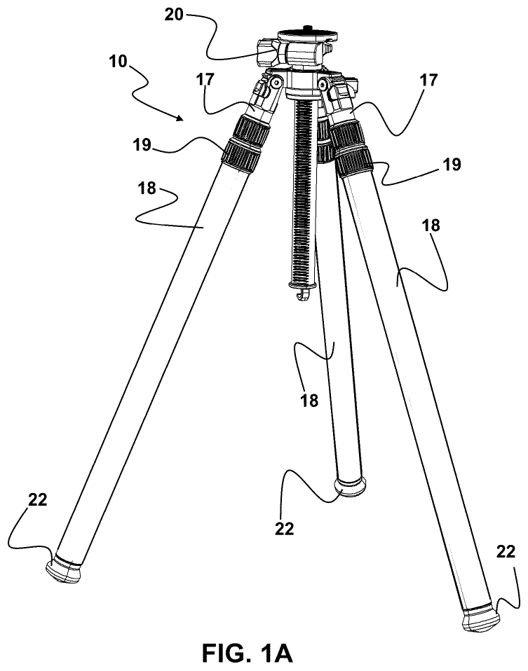

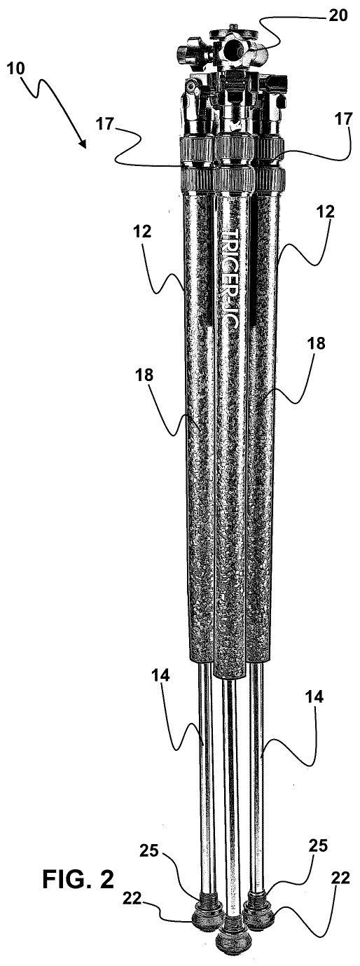

Now referring to drawings in FIGS. 1-8, wherein similar components are identified by like reference numerals, there is seen in FIG. 1 a depiction of the tripod device 10 herein in a deployed or as-used positioning with the plurality of legs 12 extended from their collapsed positioning such as shown in FIG. 2 where the second member sections 18 are slid within the axial passage 16 of the first member sections 17 which support the platform 20.

The legs 12 of the tripod device 10 herein and in most conventional tripods 10 include a first member section 17 which forms an upper portion of the leg 12 which supports a platform 20. The axial passage 16 within the first member section 17 is sized for sliding insertion of lower leg sections such as second member sections 18 therein. The second member section 18 is translatably engaged within the axial passage 16 running through the first member section 17 and to any lower-positioned second member sections 18. This allows for telescopic lengthening and shortening of the legs 12 between the deployed position of FIG. 1 and the collapsed positioning of FIG. 2. The device 10 is moved from the collapsed position to the deployed position by the sliding of telescopically engaged second member sections 18 out of the lower end of the first member sections 17, to thereby lengthen the legs 12 and elevate the platform 20 to a desired height above the support surface 21.

The first member sections 17 and second member sections 18 sections may removably couple with each other once the desired length of a leg 12 is achieved using a releasable lock 19 which may be positioned at the lower end of the first member sections 17. Such a releasable lock 19 for example only and in now way limiting may be a conventional twist lock where twisting in one direction of the second member section 18 fixes the two sections in a fixed coupling and twisting in the opposite direction releases the two sections from that fixed coupling allowing for translation of the second member section 18 into or out of the axial passage 16 within the first member section 17. Such releasable locks 19 might also be provided for example conventional lever locks which flip one way to lock and the other to release, or they might be pin locks which employ biased pins into recesses to hold the two member sections in a removably coupled position.

In the device 10 herein, slidably engaged cylindrical members or rods 14 are included. One of each of the rods 14 may be slidably coupled within the axial passage 16 of each of the legs 12 such that the formed rod 14 is in a stored positioned within the second member section 18 when translated fully into the axial passage 16 thereof, and for longer rods 14 may extend into the axial passage 16 within the first member section 17. The positioning of the rods 14 within the axial passage 16 running through at least the second member section 18 is preferred because such a positioning locates the weight or mass of each one of the rods 14, at the lowest point on each leg 12 when the device 10 is in an as-used positioning as shown in FIG. 1. Additionally, such a positioning allows the rods 14 to be translated from the lower end or distal end of the legs 12 while the second member section 18 is still totally collapsed or partially within or positioned around the first member section 17. Such a configuration is shown in FIG. 2.

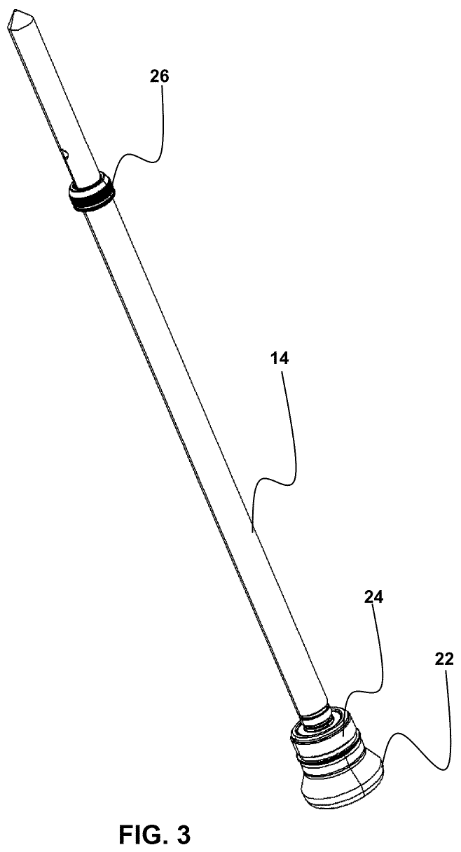

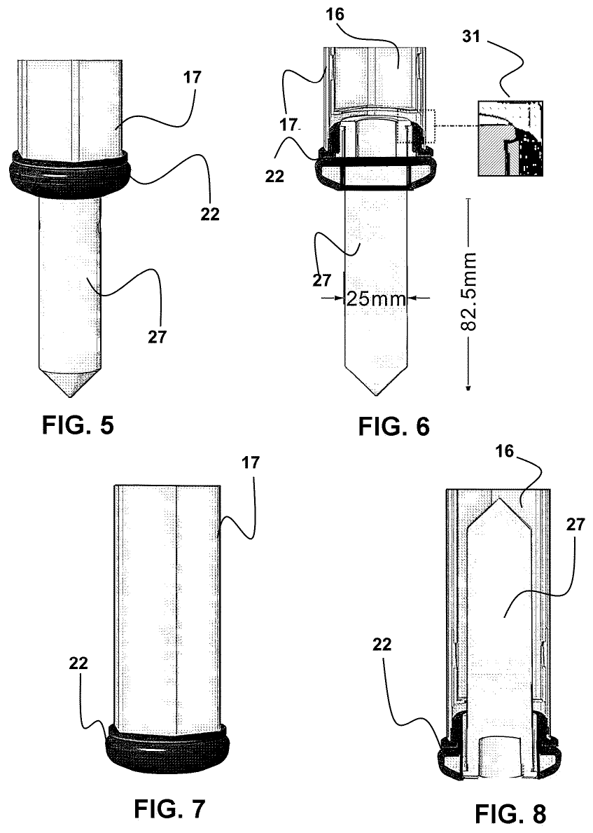

It should be noted that the second member sections 18 may also be larger than the first member sections 17 and slid there over and coupled to a fixed position by the releasable locks 19 such as in FIG. 1A. Also shown in FIG. 1A are the supports 22 which may be configured to slide into the axial passage 16 at the distal end of the leg 12 at the second member sections 18 to a frictional coupling of an exterior surface area 25 as shown in FIG. 3 therein, rather than with the collar 24 as in FIG. 1. A configuration of the supports 22 in this fashion is also shown in FIGS. 5-8 wherein the rod 14 is formed as a small ground spike 27 which may be reversed in its stowed position of FIGS. 7-8 and project from a coupling with the support 22 as in FIGS. 5-6. This allows for a small rod 14 with the pointed end for use as a ground spike 27 which concurrently positions the weight of the rod 14 in this configuration at the distal end of the legs 14 to provide increased stability from the weight of the rods 14 as well as the insertion of the ground spike 27 configuration into soil or the underlying support surface. It should be noted that the support 22 of FIGS. 5-8 could also be formed to frictionally engage in the opening of the distal end of the leg 12 and thereby reverse the positioning of the ground spike 27 configuration of the rod 14. Two engageable exterior surface areas 25 as in FIG. 3 would be positioned on opposite sides of the support 22 whereby it may be pulled from the leg 12 and flipped and re engaged to position the ground spike 27 within or projecting from the leg 12.

Each of the rods 14, whether in the elongated form, the sectional form, or the shortened ground spike form such as in FIG. 5 herein, is preferably formed of a heavy material, such as metal. Such a metal may be one or a plurality of metal materials from a group including cast iron, steel, stainless steel, iron, tungsten, copper, brass, or lead, or a similar metal which has a specific gravity or weight which is heavier than that of aluminum or fiberglass or carbon fiber which conventionally is employed to form the first member section 17 and second member section 18. The rods 14 may be solid for the most mass and weight or they may have a central passage within where less weight is provided. In this fashion their mass will provide steadiness and an anti-tipping ability to the tripod device 10 when in a deployed position where high winds or a less than level support surface is present, or when a guaranteed steadiness of the platform is required.

Engaged to a distal end of each rod 14 may be a support 22. The supports 22 may also be formed of a polymeric material such as rubber or polyurethane, or formed of a heavy material such metal also, to enhance the ability of the heavy rods 14 to provide steadiness, and they may be configured, as in FIG. 6, to engage with one end of a projecting rod 14 shown as a ground spike 27 configuration. In this configuration the support 22 couples to the perimeter edge of the second member section 18 such as with a circular recess 15.

Additionally, the rods 14 may be provided in a configuration which allows them to be removed from the axial passage 16 when not needed, or where the user wishes the tripod device 10 to be as light weight as possible. Where the rods 14 are removably coupled within the axial passage 16, a collar 24, in combination with the support 22, may be included which is frictionally, mechanically, or otherwise coupled to the distal end of the leg 12, such as at the second member section 18. In such a configuration, the rods 14 may be extended from or positioned within the axial passage 16, and one of each of the supports 22 may be engaged by the collar 24 thereon to the end of one of the second member sections 18 so that it may be extended and supported on a support surface by the supports 22. Thus, the rods 14 as in FIG. 1 may be translated to an extended position from the lower end of the formed leg 12 such as in FIGS. 1-2 or held within the legs 12 for storage.

Shown in FIG. 2 is a depiction of the tripod device 10 herein wherein in a configuration wherein the solid rods 14 may be in an extended position from the lower ends of each of the telescopic legs 12 of the tripod device 10. In this configuration, the weight or mass of the rods 14 are at the lowest end of the tripod device 10 and employ the leverage of the legs 12 to provide more support to the platform 20 to resist wind and the like which may move it.

Shown in FIG. 3 is an enlarged perspective view of one mode of the plurality of rods 14 extended from the distal ends of each leg 12, such as at the second member sections 18 of the tripod device 10 when there are two sections. The second member sections 18 may be collapsed or telescopically slid upon or within the first member sections 17 depending on the construction of the legs 12. At the distal end of each of the rods 14 is shown the engaged supports 22 which may have insertable collars 25 thereon which are sized to engage within the axial passage 16 running within the second member section 18. However, the collar 24, shown in FIG. 1, might also be employed for an exterior engagement to the second member section 18.

As noted above, FIG. 3 shows an enlarged perspective view of one of the plurality of the plurality of rods 14, employed in the tripod device 10 herein in an enlarged view. The rods 14 may be formed as solid singular members or may be formed in a tubular configuration with a center passage therein. When formed of solid members, the weight or mass provided is increased over configurations having a center passage.

Also shown in FIG. 3 is a centering ring 26 which may have a plurality of functions. In a first function, it maintains the rod centered within the axial passage 16. The centering ring 26 may also provide the may also be formed to provide the above noted releasable lock in the form of a twist-lock type configuration wherein rotating the rod 14, while it is positioned within the axial passage 16, will cause an enlargement of the circumference of the centering ring 26 and a frictional locking contact against the inside of the axial passage 16. This will hold the rod 14 in place relative to the position of the second member section 18.

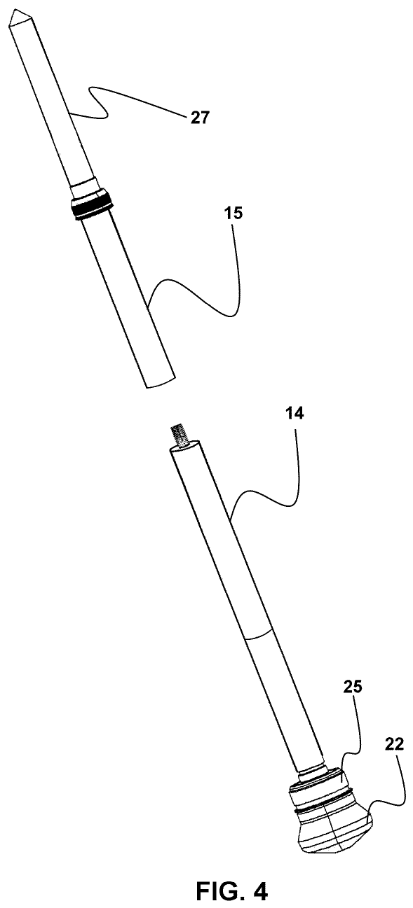

In FIG. 4 is shown the tripod device 10 having separable rods 14 to allow for adjustment of the total weight of each leg 12. As shown, the rod 14 may have at lease one secondary rod section 15 and a ground spike 26 section which are removably engageable. The ground spike section 27 may just engage with the secondary rod section 15 or the rod 14 where a shortened configuration is desirable. Such a separation may be by threaded engagement, locking projections into recesses, or other separable engagements between the separable rods 14.

Shown in FIGS. 5-8 are a configuration of the tripod device 10 herein, wherein the stability and support for the rod 14 is provided by a ground spike section 27 configured for storage within the axial passage 16 or projection therefrom. As depicted in FIGS. 5-6, when formed as the primary means for weighted support of the tripod device 10, smaller but heavy ground spike sections 27 may be held in an extended configuration projecting from a leg 14, such as from the first member section 17 and be used to puncture or form a spear to position a portion of said spike section 27 of said rod 14 into and below the support surface such as soil. A base end of the ground spike 27 may be in a coupling 31 with the support 22 to hold it projected. When not in use, such as in FIGS. 7-8, the direction of the ground spike 27 may be reversed to position it within the axial passage 16 when not needed as a ground spike.

It should be noted that while the tripod device 10 herein is shown with both first member sections 17 and second member sections 18, it may also be formed with just the first member sections 18 or with more sections. In such a configuration, the rods 14 will be slidably engaged within the axial passage 16 running through the first member section 17, and the rod will be deployable and retractable therefrom in the same fashion as were it engaged in a second member section 18. This configuration allows the user to have the benefit of the extra weight or mass of the rods 14 in a shorter more compact tripod device 10.

Further, it is envisioned herein that the rods 14 may be sold separately in a configuration which is adapted to engage within the axial passages 16 of differing tripods from differing manufacturers. In this fashion, owners of existing tripods may purchase rods 14 adapted to engage their specific tripod, and buyers of new tripods, lacking the steadiness ability provided by the rods 14 herein, may also purchase rods 14 adapted to their purchased tripod and engagement therewith.

While all of the fundamental characteristics and features of the weighted tripod device have been shown and described herein, with reference to particular embodiments thereof, a latitude of modification, various changes and substitutions are intended in the foregoing disclosure and it will be apparent that in some instances, some features of the invention may be employed without a corresponding use of other features of the invention without departing from the scope of the invention as set forth. It should also be understood that various substitutions of components for equivalent components and modifications variations may be made by those skilled in the art without departing from the spirit of the invention and such are intended to be included in the claims that follow.

What is claimed is:

1. A tripod comprising:
a platform coupled to a first end of a plurality of legs;
each of said legs extending from said first end to a distal end thereof;
an axial passage positioned within each of said legs; and
a metal rod coupled within said axial passage of each of said legs, adjacent said distal ends of said legs.

2. The tripod of claim 1 additionally comprising:
each of said legs formed of a first member section coupled to said platform;
each of said legs having a second member section telescopically coupled at a first end thereof with said first member section, and extending to said distal end of said leg; and
said metal rod coupled within said axial passage of said second member section.

3. The tripod of claim 1 additionally comprising:
a projecting portion of said metal rod translatable from said axial passage of each of said legs to a projecting position thereof, said projecting portion extending from a first end thereof at said axial passage at said distal end of said legs to a second end of said projecting portion; and
said second end of said projecting portion of said metal rod positionable to a contact upon a support surface for said tripod.

4. The tripod of claim 2 additionally comprising:
a projecting portion of said metal rod translatable from said axial passage of said second member section of each of said legs to a projecting position thereof;
said projecting portion extending from a first end thereof coupled to said second member section at said distal end of said legs to a second end of said projecting portion; and
said second end of said projecting portion of said metal rod positionable to a contact upon a support surface for said tripod.

5. The tripod of claim 3 additionally comprising:
a support coupled to said second end of said projecting portion; and
said support forming said contact with said support surface.

6. The tripod of claim 5 additionally comprising:
a first end of said support forming a frictional coupling with said distal end of said legs.

7. The tripod of claim 4 additionally comprising:
a support coupled to said second end of said projecting portion; and
said support forming said contact with said support surface.

8. The tripod of claim 7 additionally comprising:
a first end of said support forming a frictional coupling with said distal end of said legs.

9. The tripod of claim 6 wherein said frictional coupling is formed by a positioning of said first end of said support within said axial passage.

10. The tripod of claim 6 wherein said frictional coupling is a collar frictionally engaging around an exterior of said second member section.

11. The tripod of claim 8 wherein said frictional coupling is formed by a positioning of said first end of said support within said axial passage.

12. The tripod of claim 8 wherein said frictional coupling is a collar frictionally engaging around an exterior of said second member section.

13. The tripod of claim 1 additionally comprising:
a support frictionally coupled with said distal end of each of said legs;
each said metal rod having a first end coupled with said support;
each said metal rod extending to a second pointed end;
said support positionable to a first position having said metal rod positioned within said axial passage; and
said support positionable to a second position having said metal rod extending away from said distal end of said leg for an engagement of said pointed end into said support surface.

14. The tripod of claim 2 additionally comprising:
a support frictionally coupled with said distal end of each of said legs;
each said metal rod having a first end coupled with said support;
each said metal rod extending to a second pointed end;
said support positionable to a first position having said metal rod positioned within said axial passage; and
said support positionable to a second position having said metal rod extending away from said distal end of said leg for an engagement of said pointed end into said support surface.

15. The tripod of claim 6 wherein said plurality of legs is three.

16. The tripod of claim 8 wherein said plurality of legs is three.

17. The tripod of claim 15 wherein said rod is solid and formed of one or a plurality of metal materials from a group including cast iron, steel, stainless steel, iron, tungsten, copper, brass, or lead.

18. The tripod of claim 16 wherein said rod is solid and formed of one or a plurality of metal materials from a group including cast iron, steel, stainless steel, iron, tungsten, copper, brass, or lead.

19. The tripod of claim 3 wherein said rod is formed from multiple engageable rod sections.

20. The tripod of claim 3 wherein said rod is formed from multiple engageable rod sections.
